(19) United States
(12) Patent Application Publication
(10) Pub. No.: US 2010/0083372 A1
(43) Pub. Date: Apr. 1, 2010

(54) IMAGE FORMING APPARATUS AND SECURITY SETTING METHOD THEREOF

(75) Inventor: Hyun Woong Shin, Osan-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/507,915

(22) Filed: Jul. 23, 2009

(30) Foreign Application Priority Data
Sep. 30, 2008 (KR) 2008-96258

(51) Int. Cl. G06F 12/14

(52) U.S. Cl. 726/19

(57) ABSTRACT

An image forming apparatus and a security setting method thereof. The security setting method of the image forming apparatus includes supplying power initially to the image forming apparatus, displaying an administrator setting screen for the image forming apparatus, and changing a preset administrator password of the image forming apparatus from the displayed administrator setting screen.

### CROSS-REFERENCE TO RELATED APPLICATIONS

This application claims priority from Korean Patent Application No. 10-2008-0096258, filed on Sep. 30, 2008, in the Korean Intellectual Property Office, the disclosure of which is incorporated herein by reference in its entirety.

### BACKGROUND

1. Field of the Invention

Apparatuses and methods consistent with the present general inventive concept relate to an image forming apparatus and a security setting method thereof, and more particularly, to an image forming apparatus which sets an administrator password thereof, and a security setting method thereof.

2. Description of the Related Art

An image forming apparatus forms an image to be printed on paper. The image forming apparatus may include a printer, a photocopier, a facsimile, a multi-function device and so on.

Generally, an administrator password is set in the image forming apparatus to restrict a user's access for security. The administrator password is set as a default when the image forming apparatus is manufactured, and the same type of image forming apparatuses have the same administrator password which is initially set during the manufacturing thereof.

Accordingly, users or administers who use the same type of image forming apparatuses may know the set administrator password.

Changing the initially set administrator password is recommended for reinforcing security, but a user must go through many processes, such as a process of selecting an applicable menu by changing screens a couple of times and a process of changing item by item on the selected menu, to thereby change the set administrator password.

If a user is not familiar with a user interface environment of the image forming apparatus, he/she may feel inconvenienced and spend an unnecessary amount of time to change the administrator password.

Due to the foregoing inconveniences, many users continue to use the initially set administrator password without changing it, which leaves serious security issues.

Meanwhile, a user should sometimes set, for example, a network necessarily in using the image forming apparatus normally. Even in this case, a user interface of the image forming apparatus is used for such setting, and a user may feel inconvenienced.

### SUMMARY

The present general inventive concept provides an image forming apparatus and a security setting method thereof which displays an administrator setting screen for a user to input an administrator password if power is initially supplied to the image forming apparatus, and reinforces security without posing possible leakage of the administrator password.

Additional aspects and utilities of the present general inventive concept will be set forth in part in the description which follows and, in part, will be obvious from the description, or may be learned by practice of the general inventive concept.

The present general inventive concept also provides an image forming apparatus and a security setting method thereof which displays an administrator setting screen which is provided to input an item that should be set necessarily without omission and provides convenience to a user.

The foregoing and/or other features and utilities of the present general inventive concept are achieved by providing a security setting method of an image forming apparatus, the method including: supplying power initially to the image forming apparatus; displaying an administrator setting screen for the image forming apparatus; and changing a preset administrator password of the image forming apparatus from the displayed administrator setting screen.

The preset administrator password may be stored by a manufacturer of the image forming apparatus.

The method may further include determining whether power is initially supplied to the image forming apparatus.

The method may further include setting at least one of a network and a network security through the administrator setting screen.

The method may further include displaying a result of changing the administrator password.

The foregoing and/or other features and utilities of the present general inventive concept are also achieved by providing an image forming apparatus including: a display unit which displays an administrator setting screen for the image forming apparatus; a user interface which receives a user's command from the displayed administrator setting screen; and a controller which controls the display unit to display the administrator setting screen if power is supplied initially to the image forming apparatus, and changes a preset administrator password of the image forming apparatus based on the command input through the user interface.

The preset administrator password may be stored by a manufacturer of the image forming apparatus.

The controller may determine whether power is initially supplied to the image forming apparatus.

The controller may set at least one of a network and a network security with respect to the communication unit through the administrator setting screen.

The display unit may display a result of changing the administrator password.

The foregoing and/or other features and utilities of the present general inventive concept are also achieved by providing a method of setting security of an image forming apparatus, the method comprising: determining whether power is initially supplied to the image forming apparatus; and depending on the result of the determining, executing a wizard to set security and displaying an administrator setting screen to input security setting.

The foregoing and/or other features and utilities of the present general inventive concept are also achieved by providing a computer readable recording medium containing computer readable code to execute a security setting method of an image forming apparatus, the method including supplying power initially to the image forming apparatus; displaying an administrator setting screen for the image forming apparatus; and changing a preset administrator password of the image forming apparatus from the displayed administrator setting screen.

### BRIEF DESCRIPTION OF THE DRAWINGS

The above and/or other features of the present general inventive concept will become apparent and more readily appreciated from the following description of the embodiments, taken in conjunction with the accompanying drawings of which:

FIG. 1 is a block diagram of an image forming apparatus according to an exemplary embodiment of the present general inventive concept;

FIGS. 2 to 4 illustrate an administrator setting screen according to the exemplary embodiment of the present general inventive concept; and

FIG. 5 is a flowchart to describe a security setting method of the image forming apparatus according to the exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

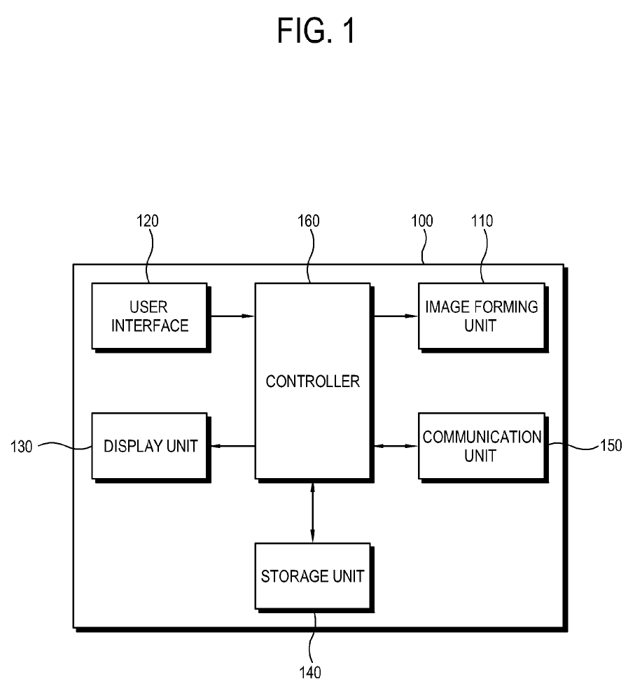

FIG. 1 is a block diagram of an image forming apparatus 100 according to an exemplary embodiment of the present general inventive concept. The image forming apparatus 100 according to the present embodiment may include a printer, a photocopier, a facsimile, a multi-function device having at least two functions, and so on.

The image forming apparatus 100 according to the present embodiment performs a print operation on at least one sheet of paper with respect to print data.

As shown in FIG. 1, the image forming apparatus 100 includes an image forming unit 110, a user interface 120, a display unit 130, a storage unit 140, a communication unit 150 and a controller 160.

The image forming unit 110 forms a print image on at least one sheet of paper based on print data if a print command is received.

Here, the print operation includes a print operation to copy after a document is scanned, a print operation of received fax data and a print operation for print data received from an external source through a host device including a server or print data stored inside (hard disc drive) or outside (USB memory stick) of the image forming apparatus 100.

The user interface 120 receives data from a user. The user interface 120 may include a key button (hereinafter, to be called “hard key” or “key pad”) provided in the image forming apparatus 100 or a graphic user interface (GUI) which is generated by executing a printer driver or an additional application and displayed on the display unit 130 to receive a user's input.

The user interface 120 of the image forming apparatus 100 according to embodiments of the present general inventive concept receives an administrator password as a setting value for security of the image forming apparatus 100. Here, the administrator password acts as permission with respect to a log-in on an administrator mode so that setting and change in all environments of the image forming apparatus 100 is available without additional restriction on access.

Meanwhile, the user interface 120 may receive at least one of an Internet protocol (IP) address, a subnet mask and a gateway address of the image forming apparatus 100 as a setting value to set a network of the image forming apparatus 100.

Further, the user interface 120 may receive at least one of an IP address, a port, a log-in ID and a password for an authentication server (not shown) as a setting value to authenticate a network of the image forming apparatus 100.

The display unit 130 displays setting and operation states of the image forming apparatus 100, and may display a graphic user interface (GUI) screen to receive various setting values from a user. The display unit 130 may further display a result of setting an administrator password according to an input administrator password.

The display unit 130 may include a thin film transistor-liquid crystal display (TFT-LCD) and a driver (not shown) to drive the TFT-LCD.

The storage unit 140 stores therein various setting information input through the user interface 120. The storage unit 140 includes a built-in storage medium such as an hard disc drive (HDD), a read only memory (ROM) and a random access memory (RAM) or an external or portable storage medium such as a universal serial bus (USB) memory device and a memory card (memory stick, a compact flash memory card, and a multi media card).

Meanwhile, the storage unit 140 (e.g., ROM) stores therein a system program of the image forming apparatus 100, various setting information and information used to determine whether power is initially supplied to the image forming apparatus 100 (hereinafter, to be called OutofBox information). The OutofBox information preferably has a flag and is at least one bit long. The OutofBox flag is set when the image forming apparatus 100 is manufactured, and is not set anymore if cleared thereafter. Accordingly, the image forming apparatus 100 according to the present general inventive concept may determine that power is initially supplied to the image forming apparatus 100 if the OutofBox flag is set.

The communication unit 150 performs a communication with the outside including a host device and a server (including a security server). The communication unit 150 may include a wired/wireless communication module to be connectable to an external device in a network by a local or predetermined protocol, or a USB port to be connectable to a portable storage medium such as a USB memory device.

The image forming apparatus 100 according to the present general inventive concept performs a network authentication with respect to a security server through the communication unit 150. Here, the network authentication may be performed through at least one of a lightweight directory access protocol (LADP) and a KERBEROUS protocol.

The controller 160 controls the image forming apparatus 100 as a whole. More specifically, the controller 160 executes a wizard to set security of the image forming apparatus 100, displays a generated administrator setting screen on the display unit 130 and receives a setting value for the displayed administrator setting screen through the user interface 120 if power is initially supplied to the image forming apparatus 100.

Here, if power is supplied to the image forming apparatus 100, the controller 160 determines whether power is supplied to the image forming apparatus 100 initially after its launch. More specifically, the image forming apparatus 100 may determine through the OutofBox flag stored in the storage unit 140 (e.g., ROM) whether power is initially supplied to the image forming apparatus 100.

That is, the controller 160 determines that power is initially supplied to the image forming apparatus 100, executes the wizard to set security and displays an administrator setting screen on the display unit 130 if the OutofBox flag is set. The controller 160 neither executes the wizard to set additional security nor displays the administrator setting screen if the OutofBox is cleared.

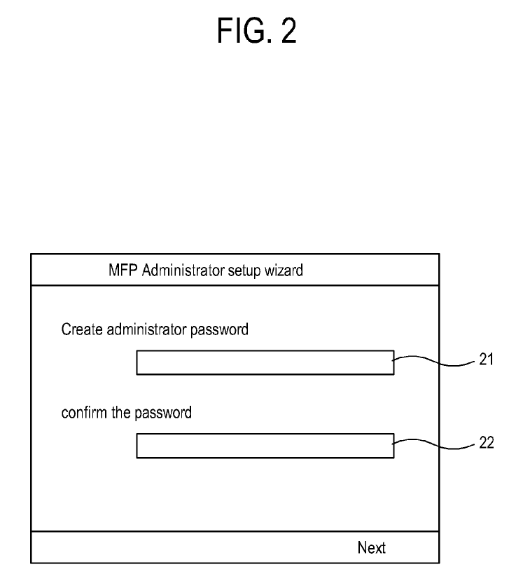

FIGS. 2 to 4 illustrate an administrator setting screen according to the exemplary embodiment of the present general inventive concept.

The controller 160 automatically executes a wizard to set security without an additional command or request from a user if the image forming apparatus 100 initially receives power and is driven after its launch. As shown in FIG. 2, the controller 160 displays the administrator setting screen on the display unit 130 to receive a setting value for security setting.

Here, the setting value for the security setting may include an administrator password to permit the administrator mode. Referring to FIG. 2, the administrator setting screen may include at least one of input fields 21 and 22 to input the administrator password.

A user inputs the administrator password in the concerned input fields 21 and 22 through the user interface 120, corresponding to the displayed administrator setting screen. More specifically, a user may change a preset administrator password of the image forming apparatus 100 from the displayed administrator setting screen. Here, the preset administrator password is an administrator password which is stored in advance by a manufacturer of the image forming apparatus while it is manufactured.

Changing the administrator password as described above may include an initial input of the administrator password. That is, according to another exemplary embodiment of the present general inventive concept, the image forming apparatus 100 may be launched without a predefined password. In this case, the input administrator password becomes an administrator password that is initially input.

If the administrator password is set according to the execution of the wizard or if the preset administrator password is changed, the administrator password is set or changed before the image forming apparatus 100 is used. Thus, potential exposure of the administrator password is notably reduced and the security is reinforced.

As the administrator password may be set or changed by a wizard that is executed automatically, a user does not need to select a menu to set or change the administrator password additionally.

Meanwhile, the controller 160 may display a setting screen to set a network of the image forming apparatus 100 if the administrator password setting is completed.

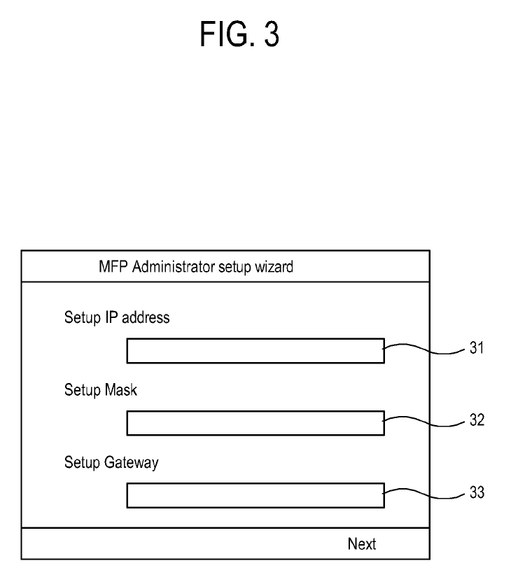

More specifically, referring to FIG. 3, the administrator setting screen for the network setting includes input fields 31, 32 and 33 to input therein at least one of an IP address, a subnet mask and a gateway address of the image forming apparatus 100, and a user inputs a setting value of the input field through the user interface 120.

The setting value for the network setting as described above may include data which should be set by a user for the image forming apparatus 100.

The image forming apparatus 100 according to the present general inventive concept receives a network setting value through the administrator setting screen if receiving power initially, and a user does not need to select a menu or input data to set the network.

If the network setting in FIG. 3 is completed, the controller 160 may display the administrator setting screen to receive a setting value to authenticate the set network.

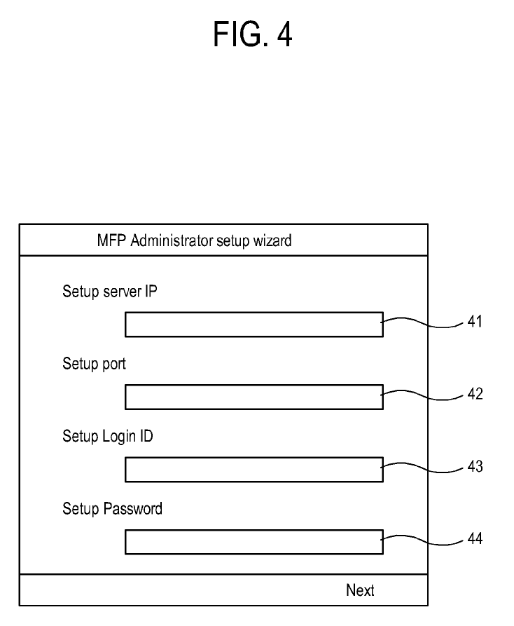

More specifically, referring to FIG. 4, the administrator setting screen which is displayed to authenticate the network includes input fields 41, 42, 43 and 44 in which at least one of an IP address, a port, a server log-in ID and a password for the authentication server is inputtable, and a user inputs a setting value of the input field through the user interface 120.

Here, the network authentication may be performed by using at least one of the LADP protocol and the KERBEROUS protocol. The administrator setting screen, which is shown in FIGS. 2 to 4, may change in execution order depending on a specific case, and one of those screens may be omitted by a user's selection. The controller 160 clears the OutofBox flag of the storage unit 140 if the setting process is completed from the administrator setting screen shown in FIGS. 2 to 4.

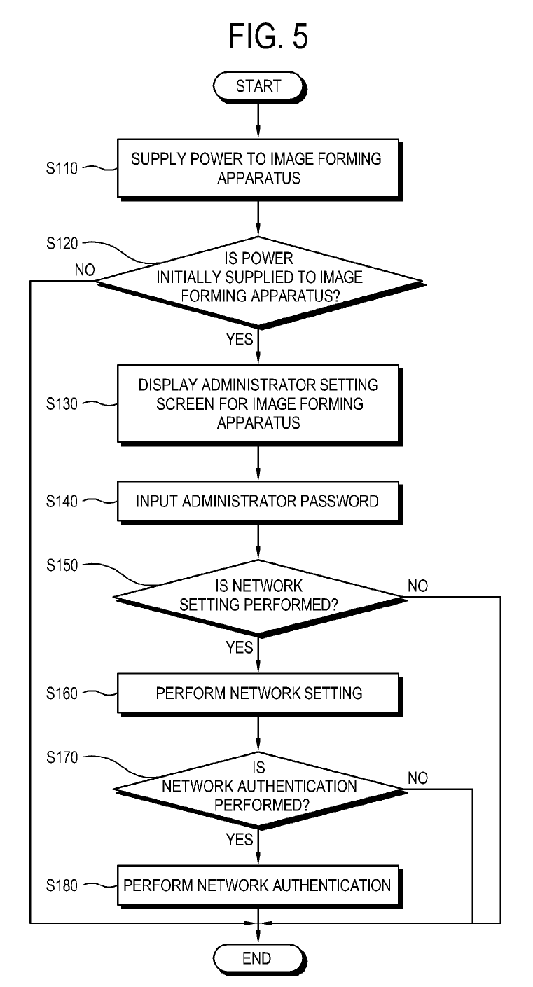

Hereinafter, the process of setting the security for the image forming apparatus 100 having the foregoing configuration will be described with reference to FIG. 5.

First, the image forming apparatus 100 receives power (operation S110).

The controller 160 then determines whether power is initially supplied to the image forming apparatus 100 at the operation S110 of supplying power (operation S120). Here, the controller 160 may determine that the power is initially supplied to the image forming apparatus 100 if the OutofBox flag of the storage unit 140 is set. If it is determined at the operation S120 that the power is initially supplied to the image forming apparatus 100 after its launch, the controller 160 executes a wizard to set the security of the image forming apparatus 100, and may display the administrator setting screen for a user (operation S130).

A user inputs the setting value of the displayed administrator setting screen (operation S140). Here, the input setting value may include an administrator password to log in to the administrator mode to set various environments of the image forming apparatus 100. If the administrator password is input, it means that the preset administrator password by the manufacturer of the image forming apparatus 100 is now changed. Also, changing the preset administrator password includes initial input of the administrator password at the operation S140 as the administrator password is not set upon the launch of the image forming apparatus 100. The operation S140 may include an operation of displaying a result of setting the inputted administrator password (change result).

If the administrator password is input at the operation S140, the controller 160 may receive a user's selection on whether to set the network for the image forming apparatus 100 through the user interface 120 (operation S150).

If a user selects to set the network at the operation S150, the controller 160 receives the network setting value(s) through the user interface 120 (operation S160). Here, the inputtable network setting value(s) may include at least one of the IP address, the subnet mask and the gateway address of the image forming apparatus 100.

Meanwhile, the controller 160 may receive the user's selection on whether to authenticate the network for the image forming apparatus 100 through the user interface 120 (operation S170).

If a user selects to authenticate the network at the operation S170, the controller 160 receives at least one authentication data including the IP address, the port, the server log-in ID and the administrator password for the authentication server through the user interface 120 (S180). The inputtable setting value may include at least one of the IP address, the subnet mask and the gateway address of the image forming apparatus 100. Here, the network authentication may be performed by using at least one of the LADP protocol and the KERBEROUS protocol.

The image forming apparatus 100 according to the present general inventive concept automatically executes a wizard to input or change the administrator password in the administrator mode upon its initial drive, and thereby not only reinforces security with reduced possibility of password exposure, but also provides convenience for a user. Thus, a user does not need to select a menu to additionally set or change the administrator password.

The wizard, which is automatically executed, allows the network setting or network authentication, which is necessary for use of the image forming apparatus 100. Thus, a user does not need to go through additional setting operations.

As described above, the image forming apparatus according to the present general inventive concept displays an administrator setting screen to input an administrator password if power is initially supplied to the image forming apparatus, and reinforces security without posing possible exposure of the administrator password.

Also, the image forming apparatus according to the present general inventive concept displays an administrator setting screen which enables an input of items that should be set necessarily in the image forming apparatus when power is initially supplied to the image forming apparatus, allows necessary data to be input without omission and provides convenience to a user.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A security setting method of an image forming apparatus, the method comprising:
supplying power initially to the image forming apparatus;
determining whether power is initially supplied to the image forming apparatus;
displaying an administrator setting screen for the image forming apparatus; and
changing a preset administrator password of the image forming apparatus from the displayed administrator setting screen.

2. The method according to claim 1, wherein the preset administrator password is stored by a manufacturer of the image forming apparatus.

3. The method according to claim 1, further comprising:
setting at least one of a network and a network security through the administrator setting screen.

4. The method according to claim 1, further comprising:
displaying a result of changing the administrator password.

5. An image forming apparatus comprising:
a display unit which displays an administrator setting screen for the image forming apparatus;
a user interface which receives a user's command from the displayed administrator setting screen; and
a controller which controls the display unit to display the administrator setting screen if power is supplied initially to the image forming apparatus, and changes a preset administrator password of the image forming apparatus based on the command input through the user interface.

6. The image forming apparatus according to claim 5, wherein the preset administrator password is stored by a manufacturer of the image forming apparatus.

7. The image forming apparatus according to claim 5, wherein the controller determines whether power is initially supplied to the image forming apparatus.

8. The image forming apparatus according to claim 5, further comprising:
a communication unit, wherein
the controller sets at least one of a network and a network security with respect to the communication unit through the administrator setting screen.

9. The image forming apparatus according to claim 5, wherein the display unit displays a result of changing the administrator password.

10. A method of setting security of an image forming apparatus, the method comprising:
determining whether power is initially supplied to the image forming apparatus; and
depending on the result of the determining, executing a wizard to set security and displaying an administrator setting screen to input security setting.

11. The method of claim 10, wherein the determining whether power is initially supplied to the image forming apparatus includes retrieving from a storage of the image forming apparatus a status of an OutofBox flag.
